(19) United States
(12) Patent Application Publication
(10) Pub. No.: US 2024/0320790 A1
(43) Pub. Date: Sep. 26, 2024

(54) DISPLAY DEVICE AND DISPLAY METHOD

(71) Applicant: PANASONIC AUTOMOTIVE SYSTEMS CO., LTD., Kanagawa (JP)

(72) Inventors: Toshiki IWAHANA, Kyoto (JP); Takayuki SUZUKI, Kanagawa (JP); Tetsuo NAKAMURA, Shiga (JP); Akitoshi YAMASHITA, Hyogo (JP); Tatsuki HOTANI, Fukui (JP)

(73) Assignee: PANASONIC AUTOMOTIVE SYSTEMS CO., LTD., Kanagawa (JP)

(21) Appl. No.: 18/614,288

(22) Filed: Mar. 22, 2024

(30) Foreign Application Priority Data
Mar. 24, 2023 (JP) 2023-048161

(51) Int. Cl. G06T 5/00; B60R 1/26

(52) U.S. Cl. CPC G06T 5/00; B60R 1/26; B60R 2300/30; G06T 2207/10016; G06T 2207/30168; G06T 2207/30252

(57) ABSTRACT

A display device includes a receiving unit configured to receive a surrounding video; a setting unit configured to receive a correction setting of image quality for the surrounding video; a determination unit configured to determine a recommended correction processing for the surrounding video; and a notification unit configured to notify of the recommended correction setting for the surrounding video based on a determination result by the determination unit and the correction setting.

### TECHNICAL FIELD

The present disclosure relates to a display device and a display method.

### BACKGROUND ART

In the related art, a video processing system has been used in which a surrounding situation can be checked by displaying a video captured by an imaging device such as a camera. Examples of such a video processing system include an electronic mirror mounted on a vehicle and the like and used. For example, the visibility of the video acquired from a surrounding environment of the vehicle may be affected by a change in weather or a change in brightness depending on a time zone. In the video processing system, various types of image processing are performed in order to improve the visibility of a driver in the vehicle.

For example, Patent Literature 1 discloses a configuration in which image analysis, environment estimation, and image correction are performed in order to perform more appropriate video processing according to an imaging environment.

### CITATION LIST

### Patent Literature

Patent Literature 1: JP2013-172224A

### SUMMARY OF INVENTION

When a surrounding video of the vehicle is displayed on the electronic mirror, the surrounding environment of the vehicle changes every moment. In addition, turning on or off an image correction function in the electronic mirror is generally performed manually. For example, when an image quality correction function is turned on, the surrounding environment is changed, and as a result, the image after correction by the correction function is excessively corrected, and the visibility of the driver may be reduced. The opposite situation may also occur. At this time, when the driver operates the electronic mirror, the driver takes time and effort, and a risk due to an operation other than driving may also occur.

The present disclosure has been made in view of the above problems, and an object thereof is to provide a configuration in which, in a display device having a video correction function, it is possible to improve the convenience for a user to use a device without reducing the visibility of the user according to an environmental change.

The present disclosure provide a display device including a receiving unit configured to receive a surrounding video; a setting unit configured to receive a correction setting of image quality for the surrounding video; a determination unit configured to determine a recommended correction processing for the surrounding video; and a notification unit configured to notify of the recommended correction setting for the surrounding video based on a determination result by the determination unit and the correction setting.

Further, the present disclosure provide a display method performed by cooperating a computer and a memory with each other. The display method includes receiving a surrounding video; receiving a correction setting of image quality for the surrounding video; determining a recommended correction processing for the surrounding video; and notifying of the recommended correction setting for the surrounding video based on a determination result and the correction setting.

Any combination of the above constituent elements, and conversion of an expression of the present disclosure between a method, a device, a system, a storage medium, a computer program, and the like are also effective in an aspect of the present disclosure.

According to the present disclosure, in the display device having a video correction function, it is possible to improve the convenience for a user to use a device without reducing the visibility of the user according to an environmental change.

### BRIEF DESCRIPTION OF DRAWINGS

FIG. 1 is a block diagram illustrating a configuration example of a video processing system according to Embodiment 1 of the present invention;

FIG. 2 is a block diagram illustrating a functional configuration example of a display device according to Embodiment 1 of the present invention;

FIG. 3 is an example diagram illustrating a correction example according to Embodiment 1 of the present invention;

FIG. 4 is a schematic diagram illustrating a display example of an electronic mirror according to Embodiment 1 of the present invention;

FIG. 5 is a flowchart of display control according to Embodiment 1 of the present invention;

FIGS. 6A to 6D are example diagrams illustrating correction examples according to Embodiment 2 of the present invention;

FIG. 7 is a schematic diagram illustrating a display example of an electronic mirror according to Embodiment 2 of the present invention;

FIG. 8 is a table illustrating a relation between a correction setting and a determination result according to Embodiment 2 of the present invention; and

FIG. 9 is a flowchart of display control according to Embodiment 2 of the present invention.

### DESCRIPTION OF EMBODIMENTS

Hereinafter, embodiments that specifically disclose a display device and a display method according to the present disclosure will be described in detail with reference to the accompanying drawings as appropriate. However, unnecessarily detailed descriptions may be omitted. For example, detailed description of well-known matters or redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

### Embodiment 1

### Device Configuration

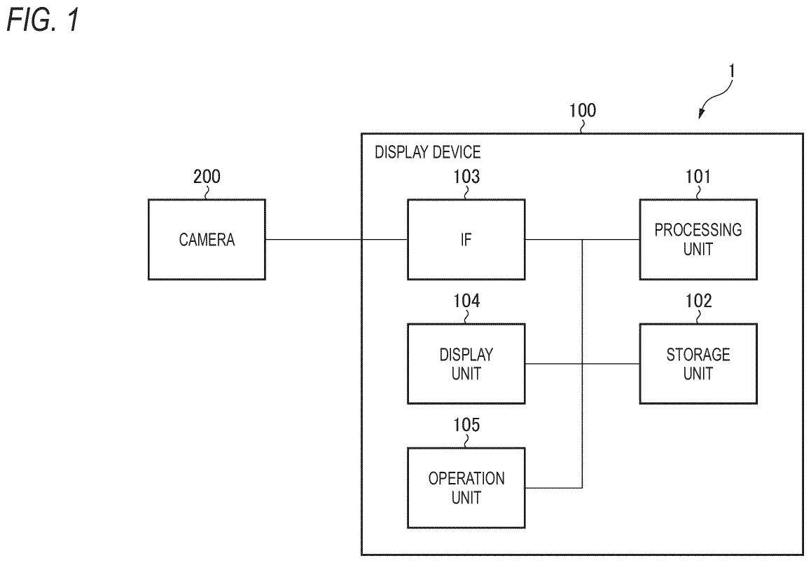

FIG. 1 is a block diagram illustrating a configuration example of a video processing system 1 according to the present embodiment. The video processing system 1 includes a display device 100 and a camera 200. In the present embodiment, a vehicle-mounted electronic mirror will be exemplified as the display device 100, however the display device 100 is not limited thereto. For example, the display device 100 may be a navigation system. In addition, a driver of a vehicle will be described as an example of a user of the display device 100.

The display device 100 includes a processing unit 101, a storage unit 102, an interface (IF) 103, a display unit 104, and an operation unit 105. The display device 100 is connected to the camera 200 via the IF 103 so as to be able to receive a video captured by the camera 200. In the present embodiment, the display device 100 and the camera 200 are mounted on the vehicle (not shown). An arrangement position and a video-imaging range of the camera 200 are not particularly limited, and for example, the camera 200 may be disposed in a rear portion of the vehicle so as to be able to capture a video of the rear of the vehicle. In addition, parts provided in the display device 100 may communicate with each other via an internal bus (not shown). Further, the video captured by the camera 200 is a moving image acquired based on a predetermined setting (for example, a frame rate or a degree of resolution), and includes a plurality of images.

The processing unit 101 reads and executes a program stored in the storage unit 102 to execute various functions to be described later. The processing unit 101 may be implemented by using, for example, a central processing unit (hereinafter, referred to as “CPU”), a micro processing unit (hereinafter, referred to as “MPU”), a digital signal processor (hereinafter, referred to as “DSP”), a graphical processing unit (hereinafter, referred to as “GPU”), or a field programmable gate array (hereinafter, referred to as “FPGA”).

The storage unit 102 includes a storage area for storing and holding various data. The storage unit 102 is, for example, a memory. The storage unit 102 may include, for example, a read only memory (hereinafter, referred to as “ROM”) that is a non-volatile memory, a flash memory, and a random access memory (hereinafter, referred to as “RAM”) that is a volatile memory.

The IF 103 is an interface that can transmit and receive various signals to and from the camera 200. Although not illustrated in FIG. 1, when the display device 100 is an electronic mirror mounted on the vehicle, the display device 100 may be connected to an electronic control unit (hereinafter, referred to as “ECU”) (not shown) disposed on a vehicle side via a controller area network (hereinafter, referred to as “CAN”) and the like. Further, the IF 103 may operate as an interface with a power source (not shown) mounted on the vehicle side in order to supply power to the display device 100.

The display unit 104 displays a video captured by the camera 200 and various notifications. The display unit 104 is, for example, a display. The display unit 104 may be formed of, for example, a liquid crystal. The operation unit 105 is a portion for receiving a user operation. The operation unit 105 is, for example, a switch or a button. The display unit 104 and the operation unit 105 may be integrally configured. For example, a touch panel display may function as the display unit 104 and the operation unit 105.

When the display device 100 is an electronic mirror, a mode of functioning as a normal mirror (hereinafter also referred to as a “mirror mode”) and a mode of displaying a surrounding video acquired via the camera 200 (hereinafter also referred to as a “display mode”) may be switched and displayed. In addition, when the vehicle is provided with the electronic mirror, the electronic mirror may be an inner mirror disposed on an upper front side of the vehicle or may be a side mirror. In addition, the display unit 104 provided in the display device 100 may display an image as a whole, or may be implemented by a plurality of regions and controlled to be able to simultaneously display a plurality of images corresponding to the plurality of regions.

### Functional Configuration

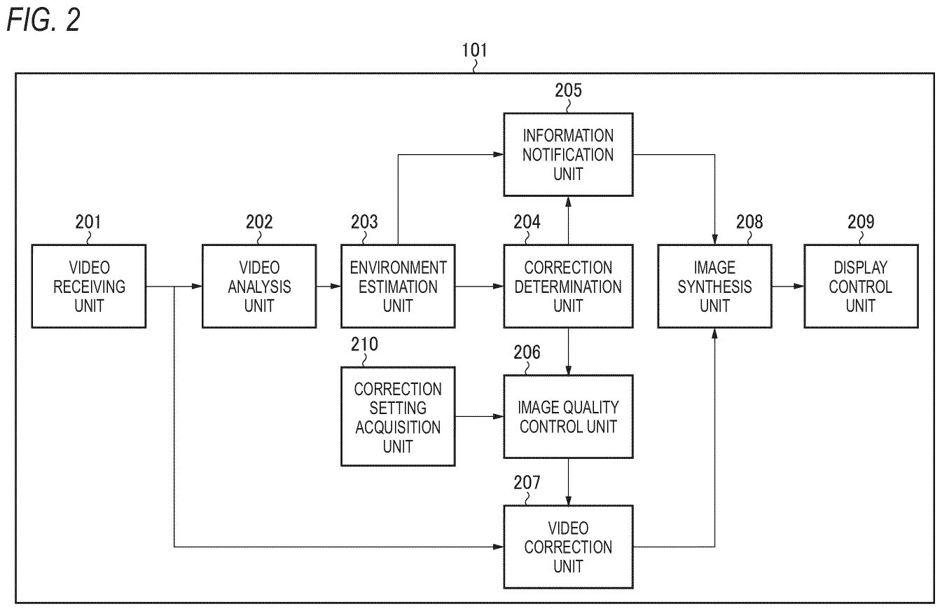

FIG. 2 is a block diagram illustrating a functional configuration example of the display device 100 according to the present embodiment. In the present embodiment, functions are implemented by the processing unit 101 of the display device 100 reading and executing various programs or various data stored in the storage unit 102. Although a description will be given focusing on the functions according to the present embodiment, the display device 100 may further provide other functions. The configuration related to the functions illustrated in FIG. 2 is an example, and the present invention is not limited thereto. Therefore, one portion 10 illustrated in FIG. 2 may be further divided into a plurality of portions, or a plurality of portions may be integrated into one portion.

A video receiving unit 201 receives the video captured by the camera 200. The video in the present embodiment is a surrounding video of the vehicle. A video analysis unit 202 applies a predetermined processing to the video received by the video receiving unit 201 and analyzes a surrounding environment. As the predetermined processing, for example, as described in Patent Literature 1, color components, luminance, contour components, and the like of each pixel constituting a video may be analyzed. A video analysis method is not limited thereto, and for example, processing for determining image quality of a video, a degree of visibility of the user, and the like may be performed using a known frequency analysis, histogram analysis, and the like.

An environment estimation unit 203 determines the surrounding environment of the vehicle based on an analysis result of the video analysis unit 202. In the environment estimation, for example, as described in Patent Literature 1, a surrounding brightness may be classified into a predetermined stage and determined. The brightness of a surrounding video of the vehicle is affected by a time zone (morning, daytime, night, and the like), weather (sunny, rain, fog, snow, and the like), and the like, and thus the environment estimation may be performed taking these into consideration. In addition, an environment estimation method is not limited thereto. For example, the surrounding environment may be estimated by combining methods described in, for example, JP2020-117247A, JP2015-191334A, and JP2019-125372A. The environment estimation unit 203 estimates the surrounding environment of the vehicle and determines which of a plurality of stages (levels) the surrounding environment corresponds to. Here, the stages may correspond to levels of correction to be applied.

A correction determination unit 204 determines whether a correction is necessary and appropriate correction contents based on a current correction processing setting and a stage determined by the environment estimation unit 203. A determination example will be described later. An information notification unit 205 generates a display for notifying the driver via the display unit 104 based on an estimation result by the environment estimation unit 203 and a determination result by the correction determination unit 204.

An image quality control unit 206 causes a video correction unit 207 to execute processing on the video received by the video receiving unit 201. The image quality control unit 206 performs image quality control for the video based on a correction setting by the driver acquired from a correction setting acquisition unit 210 and the determination result by the correction determination unit 204. The video correction unit 207 executes a correction processing to the video received by the video receiving unit 201 based on an instruction from the image quality control unit 206. A content of the correction processing is not particularly limited, but for example, when an instruction indicating that the correction processing is not necessary is received based on the adjustment of luminance levels or the color components, edge enhancement, or the instruction from the image quality control unit 206, the video correction unit 207 may output the video received by the video receiving unit 201 as it is. In addition to the correction processing, the video correction unit 207 may perform preprocessing related to the adjustment for display on the video received by the video receiving unit 201.

An image synthesis unit 208 synthesizes the display generated by the information notification unit 205 and the video output from the video correction unit 207. When there is no display generated by the information notification unit 205 or no video output from the video correction unit 207, only one of the display and the video may be output.

A display control unit 209 displays the video generated by the image synthesis unit 208 via the display unit 104. A correction setting acquisition unit 210 acquires a correction setting made by a driver operation via the operation unit 105.

### Correction Example

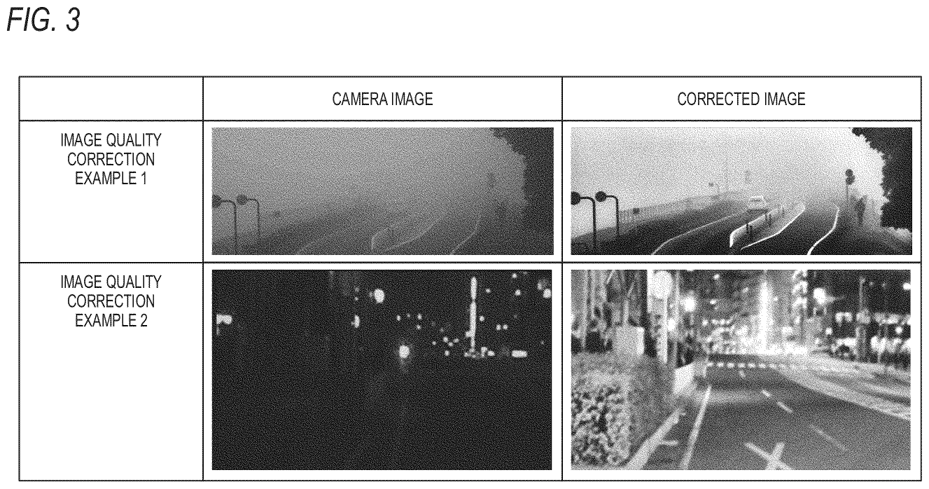

FIG. 3 is a diagram illustrating a correction example of the video according to the present embodiment. In the present embodiment, the video is displayed on the display unit 104 in two stages, i.e., with correction and without correction. An upper example in FIG. 3 shows an example in which fog occurs around the vehicle. In this case, the fog is also recorded in the video acquired by the camera 200, and the visibility to the surrounding of the driver decreases. In such a case, the visibility can be improved by correcting the video.

A lower example in FIG. 3 shows a state in which the surrounding of the vehicle is dark. In this case, the entire video acquired by the camera 200 becomes dark, and the visibility of the surrounding of the driver decreases. In such a case, the visibility can be improved by correcting the video.

### Display Example

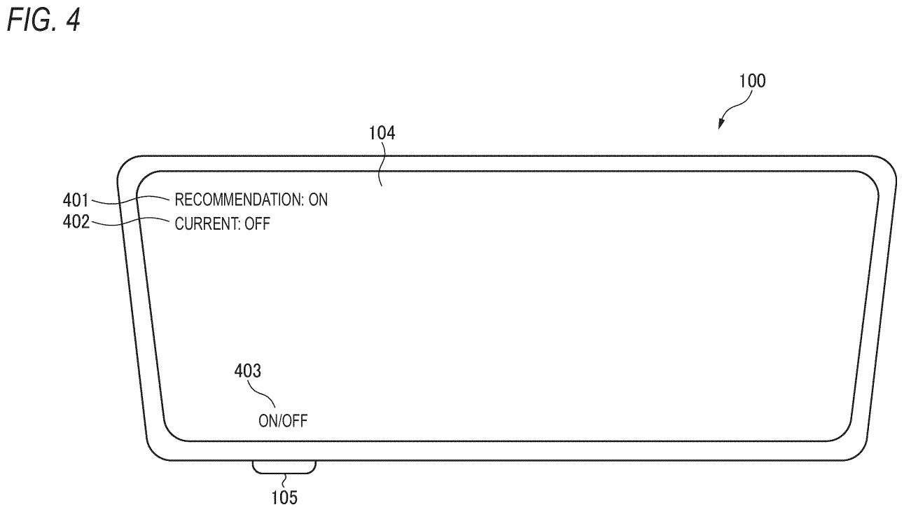

FIG. 4 is a schematic diagram illustrating a display example of the display device 100 according to the present embodiment, that is, the electronic mirror. The display device 100 includes the display unit 104 on which a video is displayed and switches serving as the operation unit 105 which can receive an operation of the driver. In addition, the display unit 104 includes display icons 401 to 403 as the display generated by the information notification unit 205 illustrated in FIG. 2.

The display icon 401 indicates a recommended setting of a correction function based on a video analysis result. Here, “ON” is indicated and it is recommended to turn on the correction function. The display icon 402 indicates a current correction function setting. Here, “OFF” is indicated and it is recommended to turn off the correction function. The display icon 403 indicates that the correction function can be turned on and off in association with a position of the operation unit 105. Therefore, the driver can switch the setting of the correction function by operating the operation unit 105.

The example in FIG. 4 shows an example in which various notifications are made on the display unit 104, and the present invention is not limited thereto. For example, a notification may be made using a light emitting unit such as a light emitting diode (hereinafter, referred to as a LED) or a lamp (not shown) provided in the electronic mirror, or an audio output unit such as a speaker. For example, the LED may be turned on, or a notification may be made using a predetermined color, a blinking cycle, and the like. In addition, a notification may be made in cooperation with another device provided in the vehicle on which the electronic mirror is mounted.

In the example in FIG. 4, display icons are displayed in a superimposed manner on the video, but the present invention is not limited thereto. For example, in order to further improve the visibility of the video, the display icons may be displayed transparently. In addition, the arrangement and display formats of the display icons are not limited, and the display icons may be arranged at positions at which it is less likely to affect the user's visibility of the video, or colors may be switched. For example, when the recommended setting and the correction setting match with each other, the display icons may be displayed in colors or the like that are as inconspicuous as possible.

For example, during driving or the like, it is preferred that a user's manual operation on the display device is as few as possible. Therefore, for example, the switching of the correction setting made by the user may be performed by voice input. The display device 100 may include a voice input unit such as a microphone, and the input for setting switching may be performed using the voice input unit.

### Processing Flow

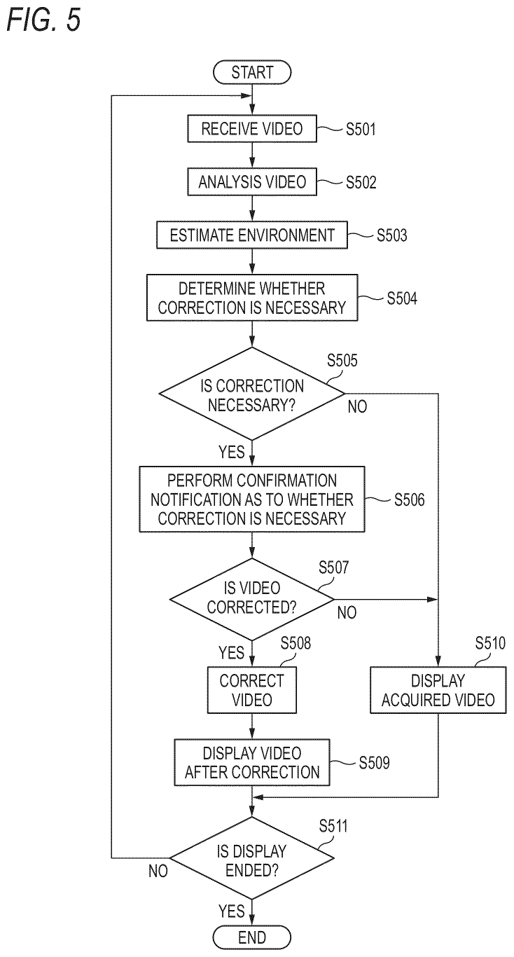

FIG. 5 is a flowchart of a display method of an electronic mirror as the display device 100 according to the present embodiment. The processing flow may be executed by, for example, the processing unit 101 reading the programs or various data stored in the storage unit 102. Here, in order to simplify the description, a main body of processing will be collectively described as the processing unit 101.

The processing unit 101 receives the video captured by the camera 200 (step S501). The setting (a frame rate, an imaging range, and the like) of the received video is not particularly limited, and for example, the received video may be set in advance by the driver, or a prescribed setting may be used.

The processing unit 101 analyzes the video received in step S501 and determines the image quality of the video (step S502). As an analysis method, any method may be used in addition to the method described in Patent Literature 1.

The processing unit 101 estimates the surrounding environment based on an analysis result of step S502 (step S503). As an estimation method, any method may be used in addition to the method described in Patent Literature 1.

The processing unit 101 determines whether correction to the video received in step S501 is necessary based on an estimation result of step S503 (step S504). In the present embodiment, it is determined in two stages whether the correction is necessary for a currently received video.

In the determination step of step S504, the processing unit 101 determines whether it is determined that the correction to the video is necessary (step S505). When it is determined that the correction is necessary (step S505: YES), the processing of the processing unit 101 proceeds to step S506. On the other hand, when it is determined that the correction is not necessary (step S505: NO), the processing of the processing unit 101 proceeds to step S510.

The processing unit 101 performs a confirmation notification as to whether the correction is necessary via the display unit 104 (step S506). Specifically, when the correction setting is “OFF”, as illustrated in FIG. 4, the display icon 401 is displayed to prompt the driver to change the correction setting. On the other hand, when the correction setting is already “ON”, the display icon 402 indicates “ON”, and thus the display icon 401 may indicate that the correction is being performed.

The processing unit 101 determines whether a correction setting “ON” instruction is received from the user via the operation unit 105. When the correction setting “ON” instruction is received (step S507: YES), the processing of the processing unit 101 proceeds to step S508. When no correction setting “ON” instruction is received (step S507: NO), the processing of the processing unit 101 proceeds to step S510. When the correction setting is already “ON”, the processing of the processing unit 101 may proceed to step S508.

The processing unit 101 performs the correction processing to the video received from the camera 200 (step S508). The content of the correction processing is not particularly limited, and for example, processing such as adjusting the luminance levels or the color components may be performed.

The processing unit 101 causes the display unit 104 to display the video corrected in step S508 (step S509). Then, the processing of the processing unit 101 proceeds to step S511.

The processing unit 101 causes the display unit 104 to display the video received from the camera 200 as it is (step S510). Then, the processing of the processing unit 101 proceeds to step S511.

The processing unit 101 determines whether to end the display of the video received from the camera 200 on the display unit 104 (step S511). Examples of the case of ending the display of the video include a case in which a mode of the electronic mirror is switched to the mirror mode based on an operation of the driver. In addition, it may be a case in which an operation of the vehicle on which the electronic mirror is mounted is completed. When it is determined to end the display of the video (step S511: YES), the processing flow ends. On the other hand, when it is determined not to end the display of the video (step S511: NO), the processing of the processing unit 101 returns to step S501, and the processing is repeated.

As described above, according to the present embodiment, the display device (for example, 100) includes the receiving unit (for example, 101, 103, and 201) that receives the surrounding video, the setting unit (for example, 101, 105, and 210) that receives the correction setting of the image quality to the surrounding video, the determination unit (for example, 101, 202, 203, and 204) that determines the recommended correction processing to the surrounding video, and the notification unit (for example, 101, 103, and 205) that notifies of the recommended correction setting to the surrounding video based on the determination result by the determination unit and the correction setting.

Accordingly, in the display device having a video correction function, it is possible to improve the convenience for the user to use a device without reducing the visibility of the user according to an environmental change.

In addition, a notification is performed using any one of message display by the display unit (for example, 104), light emission by a light emitting unit (for example, an LED) (not shown), and audio by the audio output unit (for example, a speaker).

Accordingly, it is possible to notify the user by using various user interfaces, and it is possible to improve the convenience for the user of the display device.

The switching of the correction setting is received using any one of a screen operation in the display unit (for example, 104), a switch operation in the operation unit (for example, 105), and a voice operation by the audio output unit (for example, a speaker).

Accordingly, it is possible to receive an instruction to switch the correction setting using various user interfaces from the user, and it is possible to improve the convenience for the user of the display device.

### Embodiment 2

Embodiment 2 of the present invention will be described. The description of the configuration overlapping with those of Embodiment 1 will be omitted, and the description will focus on a difference. In Embodiment 2, a description will be given of a configuration in which correction recommendation levels are determined in a plurality of stages, and the display is switched based on a relation between a correction setting and a determination result at that time.

### Correction Example

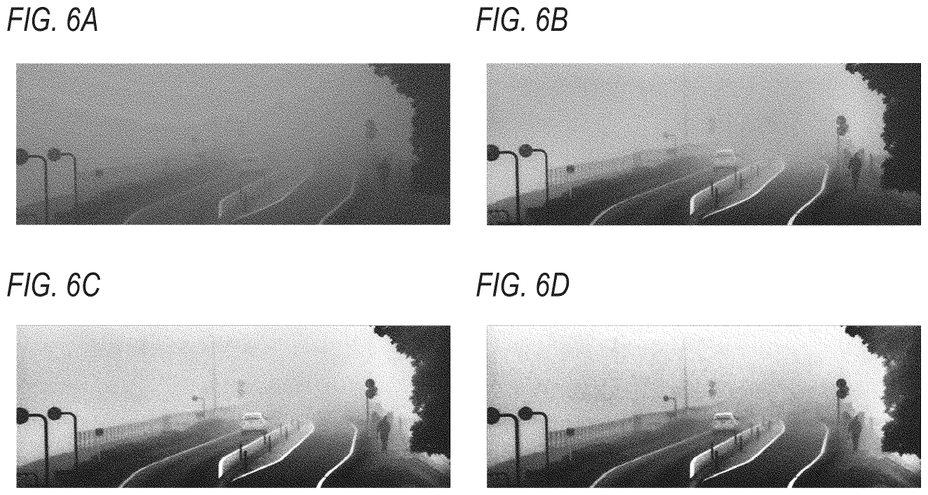

FIG. 6 is a diagram illustrating a correction example according to the present embodiment. FIG. 6A is an example of an image captured by the camera 200 received when fog occurs around a vehicle. In the present embodiment, the correction can be performed in three stages. FIGS. 6B to 6D show examples in which intensities of the correction are increased in order with respect to the image shown in FIG. 6A.

In relation to the visibility of a video, what degree of correction intensity in FIGS. 6B to 6D is most suitable may vary depending on a surrounding situation, the preference of a driver, and the like. Therefore, in the present embodiment, the notification and the execution of the correction are switched according to a combination of a correction setting by the driver and an estimation setting.

Therefore, the environment estimation unit 203 according to the present embodiment may determine which of a plurality of stages (levels) corresponds to a surrounding environment of the vehicle in more detail than that of Embodiment 1. In addition, the correction determination unit 204 according to the present embodiment determines whether correction is necessary and more appropriate correction contents based on a current correction processing setting and a stage determined by the environment estimation unit 203.

### Display Example

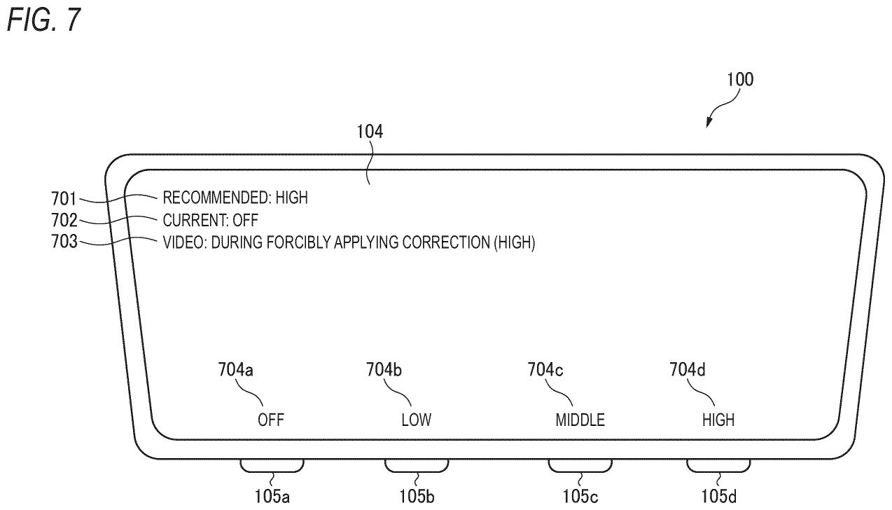

FIG. 7 is a schematic diagram illustrating a display example of the display device 100 according to the present embodiment, that is, an electronic mirror. The display device 100 includes the display unit 104 on which an image is displayed and four switches 105a to 105d serving as the operation unit 105 which can receive an operation of the driver. As will be described in detail later, in the present embodiment, the correction setting can be made in four stages, i.e., “off”, “low”, “middle”, and “high”. In addition, the example in which four switches are provided for the four settings is shown, and only one switch may be provided, and settings may be switched in order by operating the switch a plurality of times. It is more preferable to provide one switch corresponding to one setting because the number of times the driver operates is reduced.

In addition, the display unit 104 includes display icons 701 to 703 and 704a to 704das the display generated by the information notification unit 205 illustrated in FIG. 2. The display icon 701 indicates a recommended setting of a correction function based on a video analysis result. Here, “high” is indicated and it is recommended to strengthen the correction function. The display icon 702 indicates a current correction function setting. Here, “OFF” is indicated and it is recommended to turn off the correction function. The display icon 703 shows information on the correction to a currently displayed video. As will be described in detail later, when a level of the recommended setting deviates from a level of the current correction function setting by a certain amount or more, it indicates that processing different from the setting is forcibly performed in consideration of safety and the like. The example in FIG. 7 indicates that the video obtained by forcibly performing a “high” level correction processing is displayed, in consideration of the fact that a level of the recommended setting is “high” and the current correction function setting is “off”.

The display icons 704a to 704d indicate that any one of the correction functions can be set in association with the positions of the switches 105a to 105d. Therefore, the driver can switch the setting of the correction functions by operating the switches 105a to 105d. The setting switching of the correction functions is not limited to the switch operation, and may be a screen operation using a touch panel display, a voice operation using a microphone, a gesture operation using a camera, and the like.

### Level Example

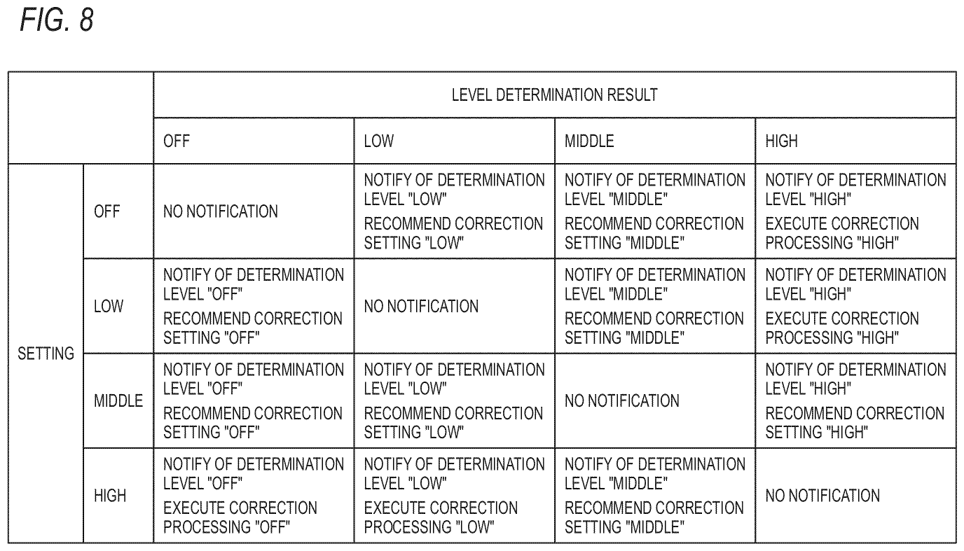

FIG. 8 is a table illustrating the control on a device side according to a correspondence relation between the setting of the correction functions and a determination result of a correction level to be applied which is determined on the device side according to the present embodiment. As described above, in the present embodiment, the correction setting can be made in the four stages, i.e., “off”, “low”, “middle”, and “high”, and it is possible to determine which stage is recommended.

In the present embodiment, when a level of the correction setting matches a level of the determination result, the notification of the setting switching (hereinafter also referred to as “recommendation”) is not performed. On the other hand, when the level of the correction setting does not match the level of the determination result, a recommendation related to the switching is performed together with the determination result. Further, in a case in which the level of the correction setting does not match the level of the determination result and there is a deviation or a difference equal to or larger than a predetermined threshold value or in a case in which there is a predetermined combination, the correction processing is performed without waiting for a setting change by the driver, and then the recommendation related to the switching is performed together with the determination result.

In the present embodiment, as illustrated in FIG. 8, when there is a level deviation of two or more stages, or when there is a predetermined combination, a forced correction processing is performed. More specifically, for example, when a level of the correction setting is “high” and the determination result is “off”, no correction processing is performed. When the correction setting is “off” and the determination result is “high”, the correction processing is forcibly performed at the “high” level.

FIG. 8 illustrates an example in which levels of four stages are used, but the present invention is not limited thereto, and the correction may be controlled in five or more stages as long as the correction can be applied in finer stages. In addition, operation contents in each combination are also an example, and may be controlled to perform other operations.

### Processing Flow

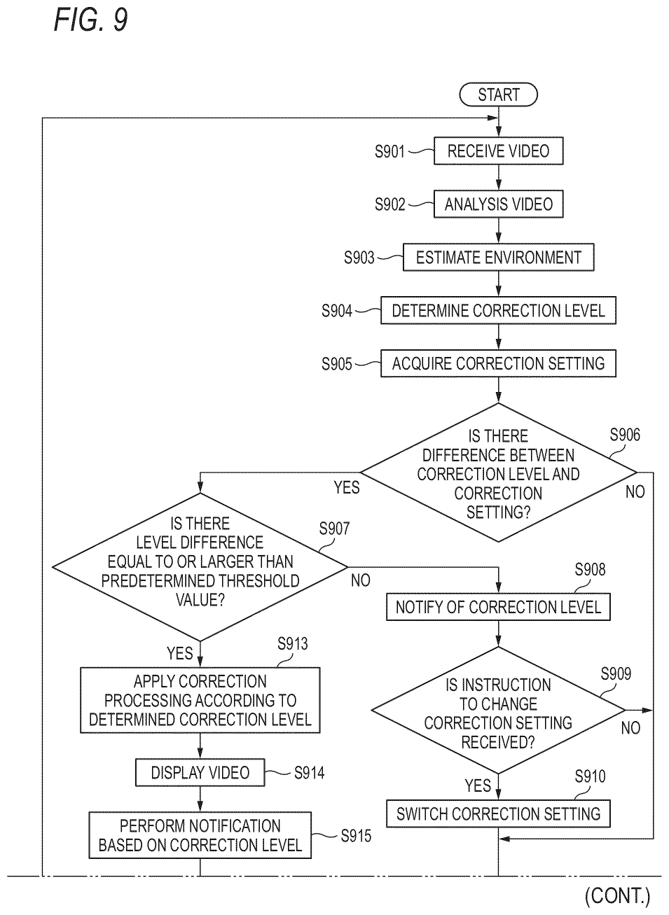

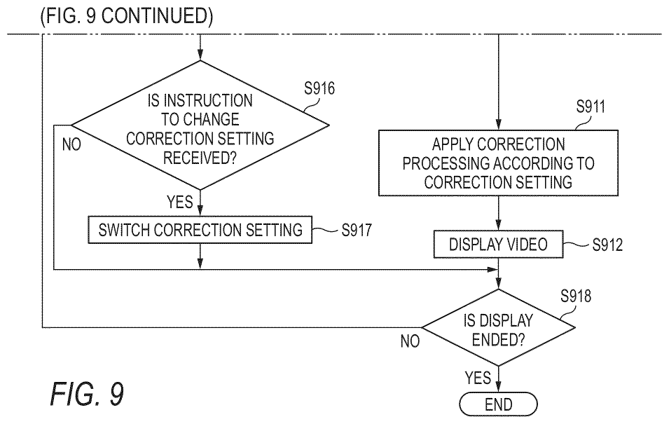

FIG. 9 is a flowchart of a display method of the electronic mirror as the display device 100 according to the present embodiment. The processing flow may be executed by, for example, the processing unit 101 reading the programs or various data stored in the storage unit 102. Here, in order to simplify the description, a main body of processing will be collectively described as the processing unit 101.

The processing unit 101 receives the video captured by the camera 200 (step S901). The setting (a frame rate, an imaging range, and the like) of the received video is not particularly limited, and for example, the received video may be set in advance by the driver, or a prescribed setting may be used.

The processing unit 101 analyzes the video received in step S901 and determines the image quality of the video (step S902). As an analysis method, any method may be used in addition to the method described in Patent Literature 1.

The processing unit 101 estimates the surrounding environment based on an analysis result of step S902 (step S903). As an estimation method, any method may be used in addition to the method described in Patent Literature 1.

The processing unit 101 determines whether correction to the video received in step S901 is necessary based on an estimation result of step S903 (step S904). In the present embodiment, it is determined based on any one of correction levels (three stages) that the correction is necessary or not necessary and is necessary for the currently received video. In this example, any one of “off”, “low”, “middle”, and “high” is determined.

The processing unit 101 acquires a current correction setting (step S905). In this example, any one of setting values of “off”, “low”, “middle”, and “high” is acquired.

The processing unit 101 compares the correction level determined in step S904 with the correction setting acquired in step S905, and determines whether there is a difference therebetween. When there is a difference (step S906: YES), the processing of the processing unit 101 proceeds to step S907. When there is no difference (step S906: NO), the processing of the processing unit 101 proceeds to step S911.

The processing unit 101 compares the correction level determined in step S904 with the correction setting acquired in step S905, and determines whether there is a difference equal to or larger than the predetermined threshold value (step S907). For example, as described with reference to FIG. 8, it may be determined whether there is a difference between two or more stages such as “off” and “high”. Further, it may be determined whether there is a predetermined combination. The predetermined threshold value and the predetermined combination used for the determination here are defined in advance. When there is a difference equal to or larger than the predetermined threshold value (step S907: YES), the processing of the processing unit 101 proceeds to step S913. On the other hand, when there is a difference less than the predetermined threshold value (step S907: NO), the processing of the processing unit 101 proceeds to step S908.

The processing unit 101 performs a notification based on the determined correction level (step S908). At this time, the processing unit 101 may notify of a recommended correction setting based on the difference between the determined correction level and the correction setting. For example, as illustrated in FIG. 7, the display icons 701, 702, and 704a to 704d may be displayed.

The processing unit 101 determines whether an instruction to change the correction setting is received from the user via the operation unit 105 (step S909). When the instruction to change the correction setting is received (step S909: YES), the processing of the processing unit 101 proceeds to step S910. When no instruction to change the correction setting is received (step S909: NO), the processing of the processing unit 101 proceeds to step S911.

The processing unit 101 switches the correction setting based on an instruction from the user (step S910). Then, the processing of the processing unit 101 proceeds to step S911.

The processing unit 101 applies the correction processing according to the correction setting to the video received from the camera 200 (step S911). The content of the correction processing is not particularly limited, and for example, processing such as adjusting the luminance levels or the color components may be performed.

The processing unit 101 causes the display unit 104 to display the video corrected in step S911 (step S912). Then, the processing of the processing unit 101 proceeds to step S918.

The processing unit 101 applies the correction processing according to the correction level determined in step S904 to the video received from the camera 200 (step S913). The content of the correction processing is not particularly limited, and for example, processing such as adjusting the luminance levels or the color components may be performed.

The processing unit 101 causes the display unit 104 to display the video corrected in step S913 (step S914). Then, the processing of the processing unit 101 proceeds to step S915.

The processing unit 101 performs a notification based on the determined correction level (step S915). At this time, the processing unit 101 may switch the display based on the applied correction processing. For example, as illustrated in FIG. 7, the display icons 702 and 703 may be used to notify of a recommendation based on the determination result or the content of the forcibly applied correction processing. Contents and items of the display may be controlled to be different from those in the processing of step S908. For example, in the case of step S908, the content or the item of the display icon 703 may be controlled not to be displayed.

The processing unit 101 determines whether an instruction to change the correction setting is received from the user via the operation unit 105 (step S916). When the instruction to change the correction setting is received (step S916: YES), the processing of the processing unit 101 proceeds to step S917. When no instruction to change the correction setting is received (step S916: NO), the processing of the processing unit 101 proceeds to step S918.

The processing unit 101 switches the correction setting based on an instruction from the user (step S917). Then, the processing of the processing unit 101 proceeds to step S918.

The processing unit 101 determines whether to end the display of the video received from the camera 200 on the display unit 104 (step S918). Examples of the case of ending the display of the video include a case in which a mode of the electronic mirror is switched to the mirror mode based on an operation of the driver. In addition, it may be a case in which an operation of the vehicle on which the electronic mirror is mounted is completed. When it is determined to end the display of the video (step S918: YES), the processing flow ends. On the other hand, when it is determined not to end the display of the video (step S918: NO), the processing of the processing unit 101 returns to step S901, and the processing is repeated.

As described above, according to the present embodiment, the correction setting and the recommended correction processing include whether a correction processing is necessary and a level of the correction processing.

Accordingly, it is possible to determine and notify of a recommended correction processing from among a plurality of correction stages in accordance with the image quality of the surrounding video.

The display device includes the correction unit (for example, 101, 206, and 207) that executes the correction processing to the surrounding video, and the correction unit applies the correction processing corresponding to the determination result by the determination unit (for example, 101 and 204) to the surrounding video when the determination result by the determination unit and the correction setting are a predetermined combination. In addition, the display device further includes the correction unit (for example, 101, 206, and 207) that executes the correction processing to the surrounding video, and the correction unit applies the correction processing corresponding to the determination result by the determination unit (for example, 101 and 204) to the surrounding video when the determination result by the determination unit and the level of the correction setting have a difference equal to or larger than the predetermined threshold value.

Accordingly, it is possible to further improve the convenience for the user by applying the forcibly determined correction processing according to the combination of the determination result and the correction setting. In particular, in the case of the electronic mirror, the safety of the user can be improved.

In addition, the notification unit switches contents and items of the notification according to the combination of the determination result by the determination unit and the correction setting. In addition, the notification unit notifies of only the determination result when the determination result by the determination unit and the correction setting match with each other.

Accordingly, by switching the contents and the items of the notification according to the combination of the determination result and the correction setting, it is possible to further improve the user's visibility of a video being displayed.

### Other Embodiments

In addition, an electronic mirror has been exemplified as the display device according to the above embodiments. When a plurality of images can be simultaneously displayed on a display unit of the electronic mirror, videos before and after correction may be displayed side by side so as to be compared. The user may select a video to be displayed from among the videos before and after the correction.

Although various embodiments have been described above with reference to the drawings, it is needless to say that the present disclosure is not limited to such examples. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the various embodiments described above may be freely combined or coordinated in a range without deviating from the spirit of the invention.

### (Note)

The following techniques are disclosed from the above description of the embodiments.

### (Technique 1)

A display device including:
a receiving unit configured to receive a surrounding video;
a setting unit configured to receive a correction setting of image quality for the surrounding video;
a determination unit configured to determine a recommended correction processing to the surrounding video; and
a notification unit configured to notify of the recommended correction setting to the surrounding video based on a determination result by the determination unit and the correction setting.

With this configuration, in the display device having a video correction function, it is possible to improve the convenience for a user to use a device without reducing the visibility of the user according to an environmental change.

### (Technique 2)

The display device according to Technique 1, in which the correction setting and the recommended correction processing include whether a correction processing is necessary and a level of the correction processing.

With this configuration, the image quality can be set and recommended, and the convenience for the user of an electronic mirror can be improved.

### (Technique 3)

The display device according to Technique 2: further including:
a correction unit configured to execute a correction processing to the surrounding video, in which
the correction unit is configured to apply a correction processing corresponding to the determination result by the determination unit to the surrounding video when the determination result by the determination unit and the correction setting are a predetermined combination.

With this configuration, it is possible to automatically perform more appropriate image processing at the time of using the electronic mirror according to the predetermined combination. As a result, the user can more safely check a surrounding situation.

### (Technique 4)

The display device according to Technique 2, further including:
a correction unit configured to execute a correction processing to the surrounding video, in which
the correction unit is configured to apply a correction processing corresponding to the determination result by the determination unit to the surrounding video when the determination result by the determination unit and a level of the correction setting have a difference equal to or larger than a predetermined threshold value.

With this configuration, it is possible to automatically perform more appropriate image processing at the time of using the electronic mirror according to a difference between an estimation result and a setting level. As a result, the user can more safely check a surrounding situation.

### (Technique 5)

The display device according to any one of Techniques 1 to 4, in which the notification unit is configured to switch contents and items of the notification according to a combination of the determination result by the determination unit and the correction setting.

With this configuration, it is possible to notify the user of the appropriate display according to the combination of the determination result and the correction setting, and to improve the convenience for the user.

### (Technique 6)

The display device according to any one of Techniques 1 to 5, in which the notification unit is configured to notify of only the determination result when the determination result by the determination unit and the correction setting match with each other.

With this configuration, the simple display can be performed according to the combination of the determination result and the correction setting, and the visibility of the electronic mirror for the user can be improved.

### (Technique 7)

The display device according to any one of Techniques 1 to 6, in which the notification unit is configured to perform notification using any one of message display by a display unit, light emission by a light emitting unit, and audio by an audio output unit.

With this configuration, the user can be notified in various display formats.

### (Technique 8)

The display device according to any one of Techniques 1 to 7, in which
the setting unit is configured to receive switching of the correction setting by using any one of a screen operation, a switch operation, and a voice operation.

With this configuration, the correction setting from the user can be received by various operation means.

### (Technique 9)

A display method performed by cooperating a computer and a memory with each other, the display method including:
receiving a surrounding video;
receiving a correction setting of image quality for the surrounding video;
determining a recommended correction processing to the surrounding video; and
notifying of the recommended correction setting to the surrounding video based on a determination result and the correction setting.

With this configuration, in the display device having a video correction function, it is possible to improve the convenience for a user to use a device without reducing the visibility of the user according to an environmental change.

### INDUSTRIAL APPLICABILITY

The present disclosure is useful as a display device and a display method.

### CROSS-REFERENCE TO RELATED APPLICATIONS

This application is based on and claims priority under 35 USC 119 from Japanese Patent Application No. 2023-048161 filed on Mar. 24, 2023, the contents of which are incorporated herein by reference.

What is claimed is:

1. A display device comprising:
a memory storing instructions; and
a processor that implements the instructions to:
receive a surrounding video;
acquire a correction setting of image quality for the surrounding video;
determine a recommended correction processing for the surrounding video; and
notify a recommended correction setting for the surrounding video based on a determination result of the recommended correction processing and the correction setting.

2. The display device according to claim 1, wherein
the correction setting and the recommended correction processing include whether a correction processing is necessary and a level of the correction processing.

3. The display device according to claim 2,
wherein the processor implements the instructions to execute a correction processing for the surrounding video, and
when the determination result of the recommended correction processing and the correction setting are a predetermined combination, in the correction processing, a correction processing corresponding to the determination result of the recommended correction processing is applied to the surrounding video.

4. The display device according to claim 2,
wherein the processor implements the instructions to execute a correction processing for the surrounding video, and
when the determination result of the recommended correction processing and a level of the correction setting have a difference equal to or larger than a predetermined threshold value, in the correction processing, a correction processing corresponding to the determination result of the recommended correction processing is applied to the surrounding video.

5. The display device according to claim 1, wherein
in the notifying of the recommended correction setting, contents and items of the notification are changed according to a combination of the determination result of the recommended correction processing and the correction setting.

6. The display device according to claim 1, wherein
in the notifying of the recommended correction setting, only the determination result is notified when the determination result of the recommended correction processing and the correction setting match with each other.

7. The display device according to claim 1, wherein
in the notifying of the recommended correction setting, notification is performed by using any one of message display provided by a display device, light emission provided by a light emitting device, and audio provided by an audio output device.

8. The display device according to claim 1, wherein
in the acquiring of the correction setting, changing of the correction setting is obtained by using any one of a screen operation, a switch operation, and a voice operation.

9. A display method performing by cooperating a computer and a memory cooperate with each other, the display method comprising:
receiving a surrounding video;
acquiring a correction setting of image quality for the surrounding video;
determining a recommended correction processing for the surrounding video; and
notifying a recommended correction setting for the surrounding video based on a determination result and the correction setting.
